(19) United States
(12) Patent Application Publication
(10) Pub. No.: US 2004/0128318 A1
(43) Pub. Date: Jul. 1, 2004

(54) Part number request processing system and method

(75) Inventors: Chin-Huan Peng, Taipei (TW); Li-Chuan Yu, Taipei (TW); Li-Ying Huang, Taipei (TW); Wen-Cheng Chang, Taipei (TW); Yo-Huang Chang, Taipei (TW); Chien-Yi Yang, Taipei (TW)

Correspondence Address: Mr. Peter F. Corless, EDWARDS & ANGELL, LLP, 101 Federal Street, Boston, MA, 02110, US

(73) Assignee: Inventec Corporation

(21) Appl. No.: 10/395,579

(22) Filed: Mar. 24, 2003

(30) Foreign Application Priority Data
Dec. 27, 2002 (TW) 91137764

(51) Int. Cl. G06F 17/00

(52) U.S. Cl. 707/104.1

(57) ABSTRACT

A part number request processing system and method is provided which allows a part number requester to efficiently obtain the verification of the part quality. The system resides in a server having a part specification database for storing a plurality of part specification label having part information and corresponding supplier information and a part test database for storing a plurality of part test records having part information and corresponding part test information. When the server receives a request, it extracts the part number specification information and test results to verify if the parts requested meet the standard, if not met, the supplier is assessed; oppositely, if met the purchase request is sent to the supplier. After delivery of the parts, test information is entered into the server via a network system to update the part specification information and part test information to provide the verification of the part purchase request.

### FIELD OF THE INVENTION

The present invention relates to part number request processing systems and methods, and more particularly, to a system and a method for processing a part number request, which can accurately and efficiently verify purchase of a material with a requested part number.

### BACKGROUND OF THE INVENTION

Research and development (R&D) people often design product specifications according to the requirement of the customers, and at the same time search for parts and components that meet the required specifications. When a suitable part is located, the R&D people submit a part number request form (PNRF) and the merchandise people take over the purchase process according to the PNRF submitted by the R&D people.

Conventional part number management systems do not provide a complete and smooth stream of data transfer between the submission of the part number request form, the connection of the supplier, and the quality check upon arrival of the parts. Merchandise people often have to solely rely on the information given by the R&D people such as the name of the products and the supplier in order to complete the process. At the other end, import control quality (ICQ) people perform tests on the specification and features of the products upon delivery of the parts from the supplier. In the conventional process, the data transfer between the submission, purchase, and the import processes are not completely shared between the merchandise and R&D people so both the merchandise and R&D people cannot control the quality of the parts. Therefore the problem at hand is how to provide a method that has streamlined data transfer allowing corporate personnel to control the part quality of various suppliers after the part number request is submitted.

### SUMMARY OF THE INVENTION

It is a primary objective of the present invention to provide a part number request processing system and method that allowing designers and merchandisers to easily control the part quality of the suppliers.

Another objective of the present invention is to provide a part number request processing system and method that accurately and efficiently verifies the purchase of a part number request.

To achieve the above and other objectives, the present invention provides a part number request processing system comprising: a part number specification database that stores a plurality of part number specification labels, wherein each part number specification label at least comprises part number specifications and supplier information that corresponds to the part number specifications; a part number test database for storing a plurality of part number test records, wherein each part number test record comprises at least part information and part test information that corresponds to the part information; a part number verification module that extracts the part number specification and the corresponding supplier information of the part number that matches the part number request submitted by the person that requires the part number, at the same time extracts test information from the part test database, and verify the quality of the part numbers of the suppliers according to part test information; a merchandise module that submits a purchase request online to the supplier according to supplier information provided by the part number verification module when the part number verification module verifies that the quality of the parts meets the standard; and a part number import test module that updates the part specification information in the part number specification database and the part test records in the part test database according to the supplier information and test results from the request for the test result when an operator at an ICQ station logs into the part number request processing system and enters a request for test result to provide the verification of the part purchase request by the part number verification module according to the part number specification label and the part import test records.

The part number request processing method of the present invention is used in a server mainframe by establishing a part number specification database and a part test database to allow part number requesters to easily obtain a part that meets the quality standard, wherein the part number specification database is used for storing a plurality of part number specification labels, wherein each part number specification label at least comprises part number specification information and suppler information that corresponds to the part number specification information; and the part test database is used for storing a plurality of part number test records, wherein each part number test record comprises at least part information and test information that corresponds to the part information. The part number request processing method comprises: extracting the part number specification information from the part number specification database and the test results from the part test database by the server mainframe according to the part required by the part number requester when the server mainframe receives a part number request to verify by the server mainframe if the part requested meets the standard according to the part number specification information and the part number test records, if the standard is not met the supply and the supplier is assessed; oppositely, if the standard is met the purchase request is sent to the supplier to complete the purchase of the parts; when the server mainframe receives a notice of part import arrival, an operator of the ICQ station transmits the part number test information via a network system causing the server mainframe to update the part number specification labels stored in the part number specification database and the part number test records stored in the part number test database to provide the verification of the purchase of the part number request by the server mainframe according to the part number specification labels and the part number test records.

### BRIEF DESCRIPTION OF THE DRAWINGS

The present invention can be more fully understood by reading the following detailed description of the preferred embodiments, with reference made to the accompanying drawings, wherein:

FIG. 1 is a schematic block diagram of a part number request processing system according to the invention; and

FIG. 2 is a process flow diagram showing procedural steps for a part number request processing method executed by the part number request processing system shown in FIG. 1 according to the invention.

### DETAILED DESCRIPTION OF THE PREFERED EMBODIMENTS

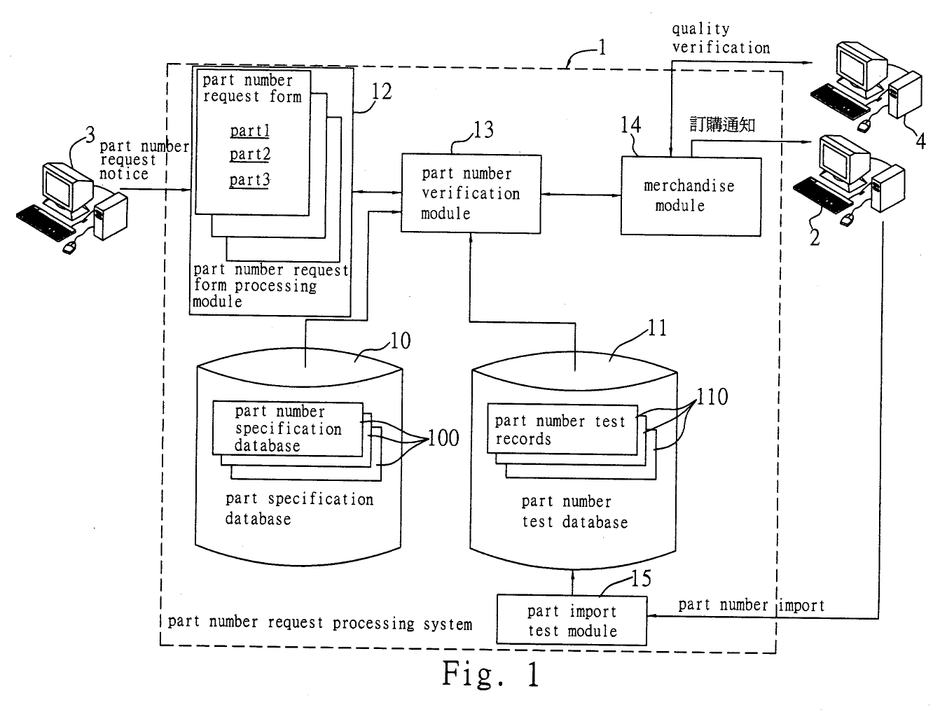

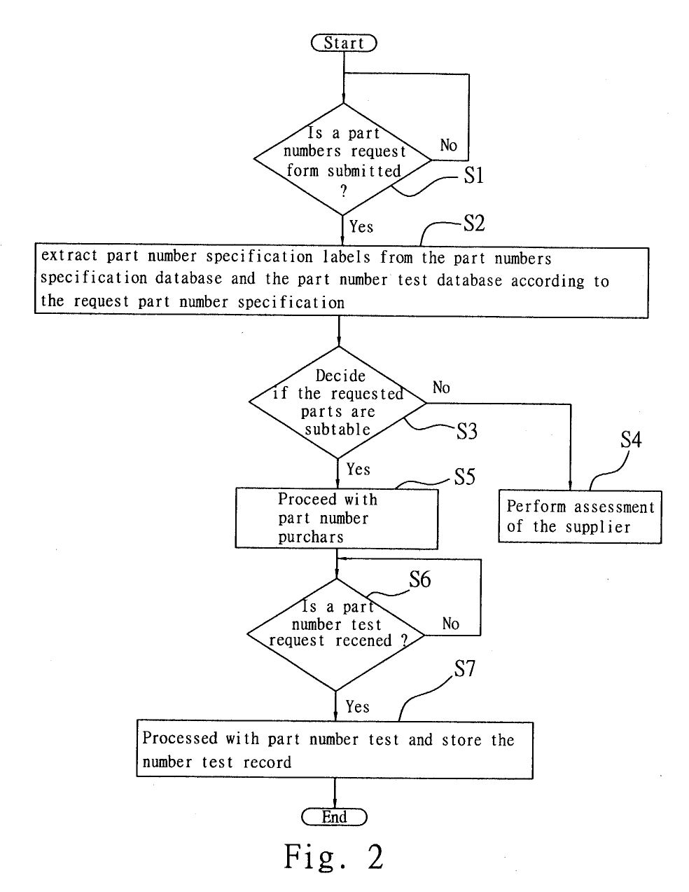

Please refer to FIGS. 1 and 2 which describes the preferred embodiment of the part number request processing system and method of the present invention; wherein FIG. 1 shows the structure of the part number request processing system and FIG. 2 shows the flow process of the part number request processing method.

FIG. 1 shows the part number request processing system (as defined by reference numeral 1) at least comprising the following components: a part number specification database 10, a part number test database 11, a part number request form processing module 12, and a part number-passing verification module 13, a merchandise module 14, and a part number test module 15.

The part number specification database 10 is used for storing a plurality of part number specification labels 100, wherein the part number specification label 100 is compiled by the supplier of the part or the part number requester. The part number specification label comprises a part name, the characteristics of the part, the features of the part, and the supplier information, and the like. By using the part number specification database 10, the part number requester (such as designers or merchandisers) can easily extract part related information.

The part number test database 11 is used for storing a plurality of part number test records 110, wherein the test records 110 are compiled by the part request companies (such as quality control personnel) after the testing of the parts. The part number requester can decide the required parts according to the test results.

The part number form processing module 12 is used to receive the part number request form submitted by the part number requester. The part number request form is provided by the part number form processing module 12 or by the part number requester (such as a designer) through a part number request form stored inside a terminal device 3. The part number request form comprises a part serial number, a part name, and supplier information, and the like. The part number form processing module 12 receives the part number request having the part number content input and outputs the inputted content to the part number-passing verification module 13. The part number-passing verification module 13 extracts the part number content such as part name, supplier information, and the like from the part number form processing module 12, the part number specification labels 100 from the part number specification database 10, and the test information of the supplier from the part number test database 11 to obtain the parts that meet the standard according to the test information.

The merchandise module 14 acts as a data relay between the merchandiser at the terminal device 4 and the part supplier at the terminal device 2, wherein the merchandise module 14 sends a request to the part supplier according to the part supplier information and part information obtained by the part number-passing verification module 13. The merchandise module 14 generates a part number request purchase notice for the part supplier to proceed with a part number request purchase process.

The part number test module 15 updates the part number test database 11. When the part number handler receives a notice after the part number test process is finished, the part number handler logs into the part number request processing system 1 of the present invention via a terminal device (not shown) to activate the part number test module 15 to provide the part number test information input fields. The test results are then inputted into the fields and a part number test record 110 is created from the test records by the part number test module 15 and stored into the part number test database 11. Therefore the management personnel of the part number request processing system 1 obtains the test result information from the part number test database 11. When a part number requester such as a designer submits a part number request form via a terminal device 3 of the part number request processing system 1 of the present invention, the part number request processing system 1 locates the parts that meet the requirements and the standard for the part number requester by the part number-passing verification module 13 by searching the part number test database 11 and the part number specification database 10. On the other side, if no suitable part is located, a part supplier assessment is performed and continues to locate a part that meets the requirement and the standard.

As shown in FIG. 2, it shows the process of flow of the part number request processing system 1 in FIG. 1. As shown in the diagram, step S1 is first executed to initiate the part number request form processing module 12 to determine if a terminal device 3 submits a part number request notice by the part number request processing system 1, if yes, the process proceeds to step S2; oppositely, the process reverts to step S1. The part number request notice comprises the part number request form submitted by the part number requester via a terminal device by email or by a part request generated by an electronic part number request form provided by the part number request form processing module 12. The electronic part number request form comprises at least a part serial number, part name, supplier, and the like information fields to provide part inputted by the part number requester.

In step S2, the part number request processing system 1 initiates the part number request form processing module 12 to obtain the part number request information, the part number-passing verification module 13 to obtain the part number specification labels 100 from the part number specification database 10, and obtains the part number test records 110 from the part number test database 11, and the process proceeds to S3.

In step S3, the part number-passing verification module 13 determines if the part number specification labels 100 and the part number test records 110 pass the standard and requirements by the part number requester, if yes, the process proceeds to step S5; oppositely, the process reverts to step S4.

In step S4, the part number-passing verification module 13 transmits the inputted part information to the merchandise module 14 and the merchandise module 14 sends the part information to the merchandiser via email. The merchandiser performs assessment of the supplier according to the part information to ensure the part number requester receives the part quality as requested.

In step S5, the part number-passing verification module 13 transmits the verified part number information to the merchandise module 14 to allow the merchandise module 14 to send a part number quality confirmation notice to the terminal device 4 and submit the part number request to the supplier by the merchandiser at the terminal device 4 via email according to the suppler in the part number specification information, the process proceeds to step S6.

In step S6, the part number request processing system 1 initiates the part number test module 15 to determine if a part number test is required. If yes, the process proceeds to step S7; oppositely, the process reverts to step S6. After receiving the parts from the supplier, the part number test request is provided by the management personnel after the part number test is performed.

In step S7, the part number request processing system 1 initiates the part number test module to create a part number test record 110 according to the part number test results inputted by the management personnel and to store the part number test records 110 in the part number test database 11.

In summarizing the above, the part number request processing system and method of the present invention ensures the part quality desired by the part number requester. The process from submitting the part name request to purchasing of the parts is speeded up and efficiently determines the quality of the parts to prevent defective parts to be taken which delays the process time and decreases the yield.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A part number request processing system, comprising:
a part number specification database for storing a plurality of part number specification labels, wherein each part number specification label comprises at least part number specification information and supplier information corresponding to the part number specification information;
a part number test database for storing a plurality of part number test records, wherein each part number test record comprises at least part information and test information corresponding to the part information;
a part number verification module for extracting the part number specification information and the corresponding supplier information of a part number according to a required part, extracting the test information from the part number test database, and verifying a quality of parts of a supplier according to the test information when a part number requester submits a part number request form;
a merchandise module for submitting a purchase request via a network system to a supplier according to the supplier information provided by the part number verification module when the part number verification module verifies that a quality of the parts meets a standard; and
a part number import test module for updating the part number specification database and the part number test database according to the supplier information and test results by a request for test results when a test personnel logs into the part number request processing system via a test station and enters a request for test results to provide verification of the part purchase request by the part number verification module according to the part number specification labels and the part number test records.

2. The system of claim 1, wherein the network system is Internet or Intranet.

3. The system of claim 1, wherein the test station comprises a computer device.

4. The system of claim 3, wherein the computer device comprises a portable laptop computer or a desktop computer.

5. A part number request processing method suitable for use in a server mainframe established with a part number specification database and a part number test database to allow a part number requester to easily obtain a part that meets a quality standard, wherein the part number specification database is used for storing a plurality of part number specification labels, each part number specification label at least comprising part number specification information and suppler information that corresponds to the part number specification information, and the part number test database is used for storing a plurality of part number test records, each part number test record comprising at least part information and test information that corresponds to the part information, the part number request processing method comprising the steps of:
(1) determining if a part number request form is received by the server mainframe; if yes, proceeding to step (2); if no, repeating step (1);
(2) extracting the part number specification information from the part number specification database and the test results from the part number test database by the server mainframe according to a part required by a part number requester when the server mainframe receives a part number request to verify by the server mainframe if the part requested meets a standard according to the part number specification information and the part number test records; if the standard is not met, a supplier being assessed; if the standard is met, sending a part number purchase request to a supplier to complete a purchase of the part number; and
(3) determining if the server mainframe receives a notice of part import arrival; if no, repeating step (3); if yes, having a test personnel at a test station transmit the part number test information via a network system, allowing the server mainframe to update the part number specification labels stored in the part number specification database and the part number test records stored in the part number test database to provide verification of a purchase of the part number request by the server mainframe according to the part number specification labels and the part number test records.

6. The method of claim 5, wherein the network system is Internet or Intranet.

7. The method of claim 5, wherein the test station comprises a computer device.

8. The method of claim 7, wherein the computer device comprises a portable laptop computer or a desktop computer.
